(19) United States
(12) Patent Application Publication
(10) Pub. No.: US 2017/0146877 A1
(43) Pub. Date: May 25, 2017

(54) Array Substrate And Liquid Crystal Display Panel

(71) Applicant: Shenzhen China Star Optoelectronics Technology Co., Ltd., Shenzhen, Guangdong (CN)

(72) Inventors: Shangcao CAO, Shenzhen, Guangdong (CN); Yong TIAN, Shenzhen, Guangdong (CN)

(73) Assignee: Shenzhen China Star Optoelectronics Technology Co., Ltd., Shenzhen, Guangdong (CN)

(21) Appl. No.: 14/891,761

(22) PCT Filed: Jun. 12, 2015
(86) PCT No.: PCT/CN2015/081304

§ 371 Date: Nov. 17, 2015

(30) Foreign Application Priority Data
Jun. 2, 2015 (CN) 201510296998.9

(51) Int. Cl. G02F 1/1362; G09G 3/36; G02F 1/1343; G02F 1/1368

(52) U.S. Cl. CPC G02F 1/136286; G02F 1/1368; G09G 3/3607; G02F 1/134336; G02F 2201/123; G09G 2310/08; G09G 2300/0809; G09G 2300/0443; G09G 2320/0242; G02F 2001/134345

(57) ABSTRACT

The disclosure provides an array substrate and a liquid crystal display panel. The array substrate includes a plurality of gate lines, main data lines, sub data lines, first switch elements and pixel regions. Each of the sub data lines is connected to one corresponding main data line through one corresponding first switch element to receive a data signal transmitted by the corresponding main data line. Each of the pixel regions includes a main pixel region connected to one corresponding main data line and one corresponding gate line and a sub pixel region connected to one corresponding sub data line and one corresponding gate line. By the above manner, the disclosure is capable of not increasing the amount of data lines to solve color shift problem by 2D1G technique, and thus the cost reduce is decreased and the crowdedness of the surrounding fanout region is avoided.

### BACKGROUND

Technical Field

The disclosure is related to liquid crystal technology field, and more particular to an array substrate and a liquid crystal display panel.

Related Art

The thin film transistor liquid crystal display with the vertical alignment (VA) mode has the characteristics of a high aperture, a high resolution and a wide viewing angle, etc., which is used by the large size panel of the LCD television. But the liquid crystal display with the VA mode usually has a problem of the large viewing angle color shift. The images viewed in different positions of the liquid crystal display will always have differences. The normal image at front view in the case of the large viewing angle is not normal, thereby causing distortion on the image. In the prior art, the above problem is usually resolved by the 2D1G technique.

The so-called 2D1G technique refers to, in the liquid crystal panel, each of the pixel regions is divided into a main pixel region and a sub pixel region with different areas, and the main pixel region and the sub pixel region in the same pixel unit are connected to different data lines and the same gate lines. The different data lines respectively provide independent data signals, and by inputting the different data signals (different gray values) to the main pixel region and the sub pixel region different display brightness and oblique view brightness is generated, thereby decreasing the color shift problem generated when it is side viewed or oblique viewed.

However, in the prior art, adoption of the 2D1G technique increases the amount of the data lines, thereby not only increasing the cost of the integrated circuit (IC), but also causing the crowdedness in the surrounding fanout region.

### SUMMARY

The technical problem mainly resolved by the disclosure is to provide an array substrate and a liquid crystal display panel, thereby solving the color shift problem caused by 2D1G technique without increasing the amount of data lines, and thus the cost is decreased and the crowdedness of the surrounding fanout region is avoided.

In order to solve the above problems, a technique scheme of the disclosure is to provide an array substrate, which includes:

a plurality of gate lines, disposed on the array substrate in parallel each other;

a plurality of main data lines, disposed on the array substrate in parallel each other;

a plurality of first switch elements;

a plurality of sub data lines, wherein each of the sub data lines is connected to one corresponding main data line through one corresponding first switch element to receive a data signal transmitted by the corresponding main data line;

a plurality of pixel regions, formed in a plurality of regions in which the gate lines and the main data lines are intersected each other, and each of the pixel regions includes:

a main pixel region, connected to one corresponding main data line and one corresponding gate line;

a sub pixel region, connected to one corresponding sub data line and one corresponding gate line;

wherein, in each of the pixel regions, the corresponding gate line connected to the main pixel region and the corresponding gate line connected to the sub pixel region are one identical gate line, and the corresponding main data line connected to the main pixel region and the corresponding sub data line connected to the sub pixel region are the main data line and the sub data line connected through one corresponding first switch element;

wherein the plurality of first switch elements are controlled by a first clock signal, the first clock signal makes the data signals of the sub data lines the data relative to the data signals of the corresponding main data lines to delay a predetermined time, such that in each of the pixel regions, a charging time of the sub pixel is smaller than a charging time of the main pixel region.

In one embodiment, the array substrate further includes a clock signal line for outputting the first clock signal;

each of the first switch elements includes:

a gate, connected to the clock signal line;

a source, connected to one corresponding main data line; and

a drain, connected to one corresponding sub data line.

In one embodiment, the first clock signal is generated by a second clock signal of a raw driving circuit of the array substrate.

In one embodiment, each of the main pixel regions includes:

a main pixel electrode;

a second switch element, which includes:
a gate, connected to the corresponding gate line of the main pixel region;
a source, connected to the corresponding main data line of the main pixel region; and
a drain, connected to the main pixel electrode;

each of the main pixel regions includes:

a sub pixel electrode;

a third switch element, which includes:
a gate, connected to the corresponding gate line of the sub pixel region;
a source, connected to the corresponding sub data line of the sub pixel region; and
a drain, connected to the sub pixel electrode.

In one embodiment, the first switch elements, the second switch elements and the switch elements are a thin film transistor.

In one embodiment, each of the sub data lines is disposed on an identical side corresponding to one main data line thereof.

In one embodiment, the sub data lines are disposed along an extending direction corresponding to the main data lines thereof.

In order to solve the above problems, another technique scheme of the disclosure provides an array substrate, which includes:

a plurality of gate lines, disposed on the array substrate;

a plurality of main data lines, disposed on the array substrate;

a plurality of first switch elements;

a plurality of sub data lines, wherein each of the sub data lines is connected to one corresponding main data line through one corresponding first switch element to receive a data signal transmitted by the corresponding main data line;

a plurality of pixel regions, formed in a plurality of regions in which the gate lines and the main data lines are intersected each other, and each of the pixel regions includes:

a main pixel region, connected to one corresponding main data line and one corresponding gate line;

a sub pixel region, connected to one corresponding sub data line and one corresponding gate line;

wherein in each of the pixel regions, the corresponding gate line connected to the main pixel region and the corresponding gate line connected to the sub pixel region are one identical gate line, and the corresponding main data line connected to the main pixel region and the corresponding sub data line connected to the sub pixel region are the main data line and the sub data line connected through one corresponding first switch element.

In one embodiment, the plurality of first switch elements are controlled by a first clock signal, the first clock signal makes the data signals of the sub data lines the data in relative to the data signals of the corresponding main data lines to delay a predetermined time, such that in each of the pixel regions, a charging time of the sub pixel is smaller than a charging time of the main pixel region.

In one embodiment, the array substrate further includes a clock signal line for outputting the first clock signal;

each of the first switch elements includes:

a gate, connected to the clock signal line;

a source, connected to one corresponding main data line; and

a drain, connected to one corresponding sub data line.

In one embodiment, the first clock signal is generated by a second clock signal of a raw driving circuit of the array substrate.

In one embodiment, each of the main pixel regions includes:

a main pixel electrode;

a second switch element, which includes:
a gate, connected to the corresponding gate line of the main pixel region;
a source, connected to the corresponding main data line of the main pixel region; and
a drain, connected to the main pixel electrode;

each of the main pixel regions includes:

a sub pixel electrode;

a third switch element, which includes:
a gate, connected to the corresponding gate line of the sub pixel region;
a source, connected to the corresponding sub data line of the sub pixel region; and
a drain, connected to the sub pixel electrode.

In one embodiment, the first switch elements, the second switch elements and the switch elements are a thin film transistor.

In one embodiment, each of the sub data lines is disposed on an identical side corresponding to one main data line thereof.

In one embodiment, the sub data lines are disposed along an extending direction corresponding to the main data lines thereof.

In order to solve the above problems, another technique scheme of the disclosure provides a liquid crystal display panel, which includes:

a first substrate, comprising:

a plurality of gate lines, disposed on the array substrate;

a plurality of main data lines, disposed on the array substrate;

a plurality of first switch elements;

a plurality of sub data lines, wherein each of the sub data lines is connected to one corresponding main data line through one corresponding first switch element to receive a data signal transmitted by the corresponding main data line;

a plurality of pixel regions, formed in a plurality of regions in which the gate lines and the main data lines are intersected each other, and each of the pixel regions includes:

a main pixel region, connected to one corresponding main data line and one corresponding gate line;

a sub pixel region, connected to one corresponding sub data line and one corresponding gate line;

a second substrate, disposed opposite to the first substrate;

a liquid crystal layer, clipped between the first substrate and the second substrate;

wherein, in each of the pixel regions, the corresponding gate line connected to the main pixel region and the corresponding gate line connected to the sub pixel region are one identical gate line, and the corresponding main data line connected to the main pixel region and the corresponding sub data line connected to the sub pixel region are the main data line and the sub data line connected through one corresponding first switch element.

In one embodiment, the plurality of first switch elements are controlled by a first clock signal, the first clock signal makes the data signals of the sub data lines the data relative to the data signals of the corresponding main data lines to delay a predetermined time, such that in each of the pixel regions, a charging time of the sub pixel is smaller than a charging time of the main pixel region.

The beneficial effect of the disclosure is: the difference from the prior art is that the sub data lines respectively corresponding to the main data lines are disposed on the array substrate to receive the data signals transmitted by the corresponding main data lines. Each of the sub data line is connected to one corresponding main data line through one corresponding first switch element to receive the data signal transmitted by the corresponding main data line. Each of the main pixel regions and each of the sub pixel regions are respectively connected to one corresponding main data line and one corresponding sub data line, each of the main pixel regions and each of the sub pixel regions are respectively connected to one identical gate line, and the corresponding main data line connected to each of the main pixel regions and the corresponding sub data line connected to each of the sub pixel regions are the main data line and the sub data line connected through one corresponding first switch element. Thus, since the first switch elements may increase the loading of the sub data lines, such that the voltages of the sub data lines are smaller than the voltages of the corresponding main data lines thereof, and the charging rates between the sub pixel regions and the main pixel regions are different. The disclosure may further control the first switch elements to turn on or turn off, such that the charging times between the sub pixel regions and the main pixel regions are different, thereby further flexibly controlling the difference between the charging rates of the sub pixel regions and the main pixel regions to solve the problem of color shift. In addition, in the disclosure, the data signal of one data line is only provided for one pixel region, there is no increase in the amount of data lines of the surrounding fanout region, and thus the cost may be decreased; meanwhile, the crowdedness of the surrounding fanout region is avoided.

### BRIEF DESCRIPTION OF THE DRAWINGS

In order to more clearly illustrate the prior art or the embodiments or aspects of the practice of the disclosure, the accompanying drawings for illustrating the prior art or the embodiments of the disclosure are briefly described as below. It is apparently that the drawings described below are merely some embodiments of the disclosure, and those skilled in the art may derive other drawings according the drawings described below without creative endeavor. In drawings:

FIG. 1 is a schematic view of an array substrate according to an embodiment of the present disclosure;

FIG. 2 is a schematic view of a charge timing state of a pixel region of the array substrate according to an embodiment of the present disclosure;

FIG. 3 is a schematic view of a liquid crystal display panel according to an embodiment of the present disclosure.

### DETAILED DESCRIPTION

The following description with reference to the accompanying drawings is provided to explain the exemplary embodiments of the disclosure. It will be apparent, however, that the disclosure may be practiced by one or more embodiments, and the specific embodiments provided herein cannot be interpreted to limit the disclosure. On the contrary, those embodiments are provided to explain the principle and the application of the disclosure such that those skilled in the art may understand the various embodiments of the disclosure and the various modifications for specific expected application.

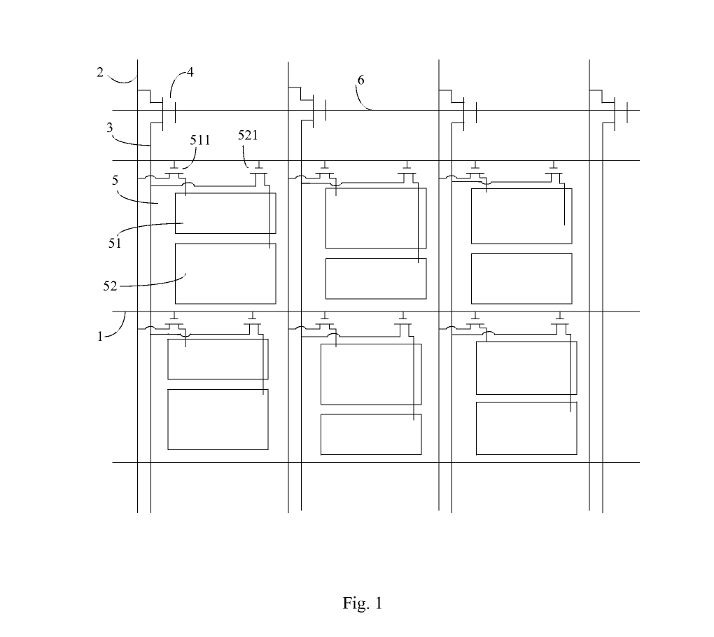

As shown in FIG. 1, in an embodiment of the disclosure, an array substrate includes a plurality of gate lines 1, a plurality of main data lines 2, a plurality of sub data lines 3, a plurality of first switch elements 4 and a plurality of pixel regions 5. The gate lines 1 are used to provide scan signals, and the main data lines 2 are used to provide data signals. In the embodiment of the disclosure, a amount of the sub data lines 3 and a amount of the main data lines 2 are the same, and each of the sub data lines 3 corresponds to one main data line 2, wherein each of the sub data lines 3 is connected to one corresponding main data line 2 through one corresponding first switch element 4 to receive a data signal transmitted by the corresponding main data line 2. The main data lines 2 may be disposed in parallel each other and the gate lines 1 may be disposed in parallel each other.

The pixel regions 5 are respectively formed in a plurality of regions in which the gate lines 1 and the main data lines 2 are intersected each other, wherein each of the pixel regions 5 includes a main pixel region 51 and a sub pixel region 52. Each of the main pixel regions 51 is respectively connected to one corresponding main data line 2 and one corresponding gate line 1, and each of sub pixel regions 52 is respectively connected to one corresponding sub data line 3 and one corresponding gate line 1. In one embodiment, in each of the pixel regions 5, the corresponding gate line 1 connected to the main pixel region 51 and the corresponding gate line 1 connected to the sub pixel region 52 are one identical gate line 1, and the corresponding main data line 2 connected to the main pixel region 51 and the corresponding sub data line 3 connected to the sub pixel region 52 are the main data line 2 and the sub data line 3 connected through one corresponding first switch element 4, i.e. in one pixel region 5, the data signal of the sub data line 3 for charging the sub pixel region 52 is provided by the main data line 2 for charging the main pixel region 51, and i.e. in the embodiment of the disclosure, the data signals for charging the main pixel region 51 and the sub pixel region 52 in one identical pixel region 5 is directly and indirectly provided by one identical main data line 2. In the embodiment of the disclosure, in the pixel region 5, an area of the main pixel region 51 is larger than an area of the sub pixel area 52. In some pixel regions 5, the area of the main pixel region 51 is larger than the area of the sub pixel area 52. In some other pixel regions 5, the area of the main pixel region 51 is smaller than the area of the sub pixel area 52.

In the embodiment of the disclosure, the sub data lines 3 respectively corresponding to the main data lines 2 are disposed on the array substrate to receive the data signals transmitted by the corresponding main data lines 2. Each of the sub data line 3 is connected to one corresponding main data line 2 through one corresponding first switch element 4 to receive the data signal transmitted by the corresponding main data line 2. Each of the main pixel regions 51 and each of the sub pixel regions 52 are respectively connected to one corresponding main data line 2 and one corresponding sub data line 3, each of the main pixel regions 51 and each of the sub pixel regions 52 are respectively connected to one identical gate line 1, and the corresponding main data line 2 connected to the each of the main pixel regions 51 and the corresponding sub data line 3 connected to each of the sub pixel regions 52 are the main data line 2 and the sub data line 3 connected through one corresponding first switch element 4. Thus, since the first switch elements 4 may increase the loading of the sub data lines 3, such that the voltages of the sub data lines 3 are smaller than the voltages of the corresponding main data lines 2 thereof, and the charging rates between the sub pixel regions 52 and the main pixel regions 51 are different. The disclosure may further control the first switch elements 4 to turn on or turn off, such that the charging times between the sub pixel regions 52 and the main pixel regions 51 are different, thereby further flexibility controlling the difference between the charging rates of the sub pixel regions 52 and the main pixel regions 51 to solve the problem of color shift. In addition, in the embodiment of the disclosure, the data signal of one data line is only provided for one pixel region 5 and the sub data lines 3 corresponding the main data lines 2 are disposed on the display region (AA region), and before the main data lines 2 enter into the display region, the sub data lines 3 are connected to the main data lines 2 through the first switch elements 4, there is no increase in the amount of data lines of the surrounding fanout region, thus the cost may be decreased; meanwhile, the crowdedness of the surrounding fanout region is avoided.

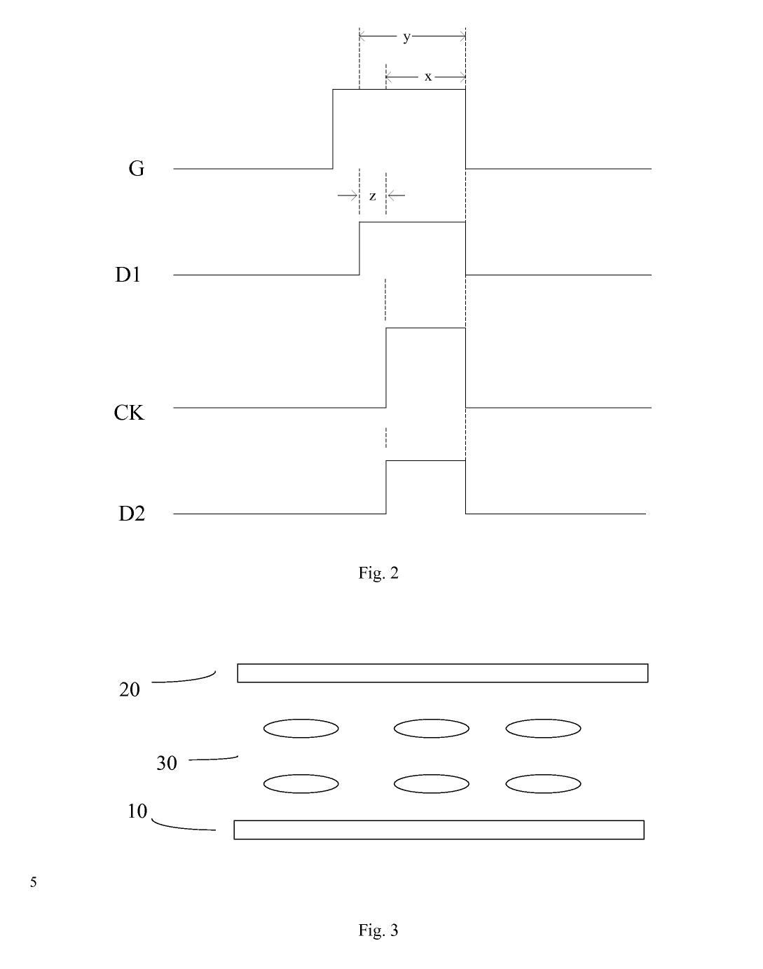

As shown in FIG. 2, the plurality of first switch elements 4 are controlled by a first clock signal CK, the first clock signal CK makes the data signals D2 of the sub data lines 3 the data relative to the data signals D1 of the corresponding main data lines 2 to delay a predetermined time z, such that in each of the pixel regions 5, a charging time x of the sub pixel 52 is smaller than a charging time y of the main pixel region 51.

In the embodiment of the disclosure, the first clock signal CK controls the first switch elements 4 to turn on or turn off. When the scan signal G provided by the gate lines 1 makes the main data lines 2 to transmit the data signals, the first clock signal CK controls the first switch elements 4 to turn off, such that the sub data lines 3 do not receive the data signals of the corresponding main data lines 2, and after a predetermined time, the first clock signal CK controls the first switch elements 4 to turn on, such that the sub data lines 3 receive the data signal of the corresponding main data lines 2. Thus, when the main data lines 2 transmits the data signals completely once, a time x for receiving the data signals of the corresponding main data lines 2 by the sub gate lines 3 is smaller than a time y for practically transmitting the data signals by the main data lines 2. That is, in one pixel region 5, the time x for charging the sub pixel region 52 is small than the time y for charging the main pixel region 51, thus the difference between the charging rate of the main pixel region 51 and the sub pixel region 52 is increased, thereby solving a problem of color shift. The predetermined time z of the data signals of the sub data lines the data delayed relative to the data signals of the corresponding main data lines can be set according to the specific needs.

As shown in FIG. 1, in the embodiment of the disclosure, the array substrate further a clock signal line 6, which is used to output the first clock signal CK. Each of the first switch elements 4 includes a gate, a source and a drain, wherein the gate of the first switch element 4 is connected to the clock signal line 6, the source of the first switch element 4 is connected to one corresponding main data line 2, and the drain of the first switch element 4 is connected to one corresponding sub data line 3.

In the embodiment of the disclosure, by using the independent clock signal line 6 to provide the first clock signal CK, it is flexibly capable of controlling the predetermined time z of the data signals D2 of the sub data lines 3 the data delayed relative to the data signals D1 of the corresponding main data lines 2.

In other embodiments of the disclosure, the first clock signal CK may be generated by a second clock signal of a raw driving circuit of the array substrate, i.e. the gate of the first switch element 4 is connected to an output terminal of the raw driving circuit and controls the raw driving circuit to output first clock signal CK according to the need, thereby further simplifying the surrounding fanout region structure and decreasing the cost.

As shown in FIG. 1, each of the main pixel regions includes a main pixel electrode (not shown in the figure) and a second switch element 511, wherein the second switch element 511 includes a gate, a source and a drain, the gate of the second switch element 511 is connected to the corresponding gate line 1 of the main pixel region 51, the source of the second switch element 511 is connected to the corresponding main data line 2 of the main pixel region 51, and the drain of the second switch element 511 is connected to the main pixel electrode. The second switch element 511 is controlled to turn on or turn off according to the scan signal provided by the gate line 1, thereby controlling the main data line 2 to charge the main pixel electrode.

Each of the main pixel regions 52 includes a sub pixel electrode (not shown in the figure) and a third switch element 521, wherein the third switch element 521 includes a gate, a source and a drain, the gate of the third switch element 521 is connected to the corresponding gate line 1 of the sub pixel region 52, the source of the third switch element 521 is connected to the corresponding sub data line 3 of the sub pixel region 52, and the drain of the third switch element 521 is connected to the sub pixel electrode. The third switch element 521 is controlled to turn on or turn off according to the scan signal provided by the gate line 1, thereby controlling the sub data line 3 to charge the sub pixel electrode.

In the embodiment of the disclosure, the first switch elements 4, the second switch elements 511 and the switch elements 521 are a thin film transistor.

In the embodiment of the disclosure, each of the sub data lines 3 is disposed on an identical side corresponding to one main data line 2 thereof. For example, all of the sub data lines 3 are disposed on a left side or a right side corresponding to one main data line 2 thereof; the pixel regions 5 charged by the data signals of the main data line 2 and the corresponding sub data lines 3 thereof are also disposed on an identical side relative to main data lines 2 or the sub data lines 2. For example, when all of the sub data lines 3 are disposed on the left side corresponding to one main data line 2 thereof, the pixel regions 5 charged by the data signals of the main data line 2 and the corresponding sub data lines 3 thereof are disposed on the left side of the sub data lines 3; when all of the sub data lines 3 are disposed on the right side corresponding to one main data line 2 thereof, the pixel regions 5 charged by the data signals of the main data line 2 and the corresponding sub data lines 3 thereof are disposed on the right side of the sub data lines 3. Such settings can improve portability on the array substrate line layout. Such disposition may be capable of increasing the portability of the circuit layout on the array substrate.

The sub data lines 3 are disposed along an extending direction corresponding to the main data lines 2 thereof, i.e. when the main data lines 2 are disposed along a straight line, the sub data lines 3 are parallel to the main data lines 2. Similarly, such disposition may be further capable of increasing the portability of the circuit layout on the array substrate and increasing the space availability of the space on the array substrate.

As shown in FIG. 3, another embodiment of the disclosure provides a liquid crystal display panel, which includes a first substrate 10, a second substrate 20 and a liquid crystal layer 30, wherein the second substrate 20 is disposed opposite to the first substrate 10, and the liquid crystal layer 30 is clipped between the first substrate 10 and the second substrate 20. The first substrate 10 includes a plurality of gate lines, a plurality of main data lines, a plurality of first switch elements, a plurality of sub data lines and a plurality of pixel regions. Each of the sub data lines is connected to one corresponding main data line through one corresponding first switch element to receive a data signal transmitted by the corresponding main data line; the plurality of pixel regions are formed in a plurality of regions in which the gate lines and the main data lines are intersected each other; each of the main pixel regions is connected to one corresponding main data line and one corresponding gate line and each of the sub pixel region is connected to one corresponding sub data line and one corresponding gate line

In each of the pixel regions, the corresponding gate line connected to the main pixel region and the corresponding gate line connected to the sub pixel region are one identical gate line, and the corresponding main data line connected to the main pixel region and the corresponding sub data line connected to the sub pixel region are the main data line and the sub data line connected through one corresponding first switch element.

In the embodiment of the disclosure, the sub data lines respectively corresponding to the main data lines are disposed on the first substrate to receive the data signals transmitted by the corresponding main data lines. Each of the sub data line is connected to one corresponding main data line through one corresponding first switch element to receive the data signal transmitted by the corresponding main data line. Each of the main pixel regions and each of the sub pixel regions are respectively connected to one corresponding main data line and one corresponding sub data line, each of the main pixel regions and each of the sub pixel regions are respectively connected to one identical gate line, and the corresponding main data line connected to each of the main pixel regions and the corresponding sub data line connected to each of the sub pixel regions are the main data line and the sub data line connected through one corresponding first switch element. Thus, since the first switch elements may increase the loading of the sub data lines, such that the voltages of the sub data lines are smaller than the voltages of the corresponding main data lines thereof, and the charging rates between the sub pixel regions and the main pixel regions are different. The disclosure may further control the first switch elements to turn on or turn off, such that the charging times between the sub pixel regions and the main pixel regions are different, thereby further flexibility controlling the difference between the charging rates of the sub pixel regions and the main pixel regions to solve the problem of color shift. In addition, in the embodiment of the disclosure, the data signal of one data line is only provided for one pixel region and the sub data lines corresponding the main data lines are disposed on the display region (AA region), and before the main data lines enter into the display region, the sub data lines are connected to the main data lines through the first switch elements, there is no increase in the amount of data lines of the surrounding fanout region, thus the cost may be decreased; meanwhile, the crowdedness of the surrounding fanout region is avoided.

The plurality of first switch elements are controlled by a first clock signal, the first clock signal makes the data signals of the sub data lines the data relative to the data signals of the corresponding main data lines to delay a predetermined time, such that in each of the pixel regions, a charging time of the sub pixel is smaller than a charging time of the main pixel region.

In the embodiment of the disclosure, the first substrate 10 may use the array substrate of the above embodiments, the specific structure and the implementation of the first substrate 10 is the same as the array substrate of the above embodiments, the specific details of the first substrate 10 is referred to the contents of the above embodiments, and thus the descriptions are omitted.

The above disclosures only are the preferred embodiments of the present disclosure it can not be used to limit the scope of the present disclosure as claimed, Therefore, the equivalent changes is made according to the present disclosure as claimed, the scope of the present disclosure is still covered.

What is claimed is:

1. An array substrate, comprising:
a plurality of gate lines, disposed on the array substrate in parallel each other;
a plurality of main data lines, disposed on the array substrate in parallel each other;
a plurality of first switch elements;
a plurality of sub data lines, wherein each of the sub data lines is connected to one corresponding main data line through one corresponding first switch element to receive a data signal transmitted by the corresponding main data line;
a plurality of pixel regions, formed in a plurality of regions in which the gate lines and the main data lines are intersected each other, and each of the pixel regions comprises:
a main pixel region, connected to one corresponding main data line and one corresponding gate line;
a sub pixel region, connected to one corresponding sub data line and one corresponding gate line;
wherein, in each of the pixel regions, the corresponding gate line connected to the main pixel region and the corresponding gate line connected to the sub pixel region are one identical gate line, and the corresponding main data line connected to the main pixel region and the corresponding sub data line connected to the sub pixel region are the main data line and the sub data line connected through one corresponding first switch element;
the plurality of first switch elements are controlled by a first clock signal, the first clock signal makes the data signals of the sub data lines the data relative to the data signals of the corresponding main data lines to delay a predetermined time, such that in each of the pixel regions, a charging time of the sub pixel is smaller than a charging time of the main pixel region.

2. The array substrate according to claim 1, wherein the array substrate further comprises a clock signal line for outputting the first clock signal;
each of the first switch elements comprises:
a gate, connected to the clock signal line;
a source, connected to one corresponding main data line; and
a drain, connected to one corresponding sub data line.

3. The array substrate according to claim 1, wherein the first clock signal is generated by a second clock signal of a raw driving circuit of the array substrate.

4. The array substrate according to claim 1, wherein each of the main pixel regions comprises:
a main pixel electrode;
a second switch element, which comprises:
a gate, connected to the corresponding gate line of the main pixel region;
a source, connected to the corresponding main data line of the main pixel region; and
a drain, connected to the main pixel electrode;
each of the main pixel regions comprises:
a sub pixel electrode;
a third switch element, which comprises:
a gate, connected to the corresponding gate line of the sub pixel region;
a source, connected to the corresponding sub data line of the sub pixel region; and
a drain, connected to the sub pixel electrode.

5. The array substrate according to claim 4, wherein the first switch elements, the second switch elements and the switch elements are a thin film transistor.

6. The array substrate according to claim 1, wherein each of the sub data lines is disposed on an identical side corresponding to one main data line thereof.

7. The array substrate according to claim 6, wherein the sub data lines are disposed along an extending direction corresponding to the main data lines thereof.

8. An array substrate, comprising:
a plurality of gate lines, disposed on the array substrate;
a plurality of main data lines, disposed on the array substrate;
a plurality of first switch elements;
a plurality of sub data lines, wherein each of the sub data lines is connected to one corresponding main data line through one corresponding first switch element to receive a data signal transmitted by the corresponding main data line;
a plurality of pixel regions, formed in a plurality of areas in which the gate lines and the main data lines are intersected each other, and each of the pixel regions comprises:
a main pixel region, connected to one corresponding main data line and one corresponding gate line;
a sub pixel region, connected to one corresponding sub data line and one corresponding gate line;
wherein, in each of the pixel regions, the corresponding gate line connected to the main pixel region and the corresponding gate line connected to the sub pixel region are one identical gate line, and the corresponding main data line connected to the main pixel region and the corresponding sub data line connected to the sub pixel region are the main data line and the sub data line connected through one corresponding first switch element.

9. The array substrate according to claim 8, wherein the plurality of first switch elements are controlled by a first clock signal, the first clock signal makes the data signals of the sub data lines the data relative to the data signals of the corresponding main data lines to delay a predetermined time, such that in each of the pixel regions, a charging time of the sub pixel is smaller than a charging time of the main pixel region.

10. The array substrate according to claim 9, wherein the array substrate further comprises a clock signal line for outputting the first clock signal;
each of the first switch elements comprises:
a gate, connected to the clock signal line;
a source, connected to one corresponding main data line; and
a drain, connected to one corresponding sub data line.

11. The array substrate according to claim 9, wherein the first clock signal is generated by a second clock signal of a raw driving circuit of the array substrate.

12. The array substrate according to claim 8, wherein each of the main pixel regions comprises:
a main pixel electrode;
a second switch element, which comprises:
a gate, connected to the corresponding gate line of the main pixel region;
a source, connected to the corresponding main data line of the main pixel region; and
a drain, connected to the main pixel electrode;
each of the main pixel regions comprises:
a sub pixel electrode;
a third switch element, which comprises:
a gate, connected to the corresponding gate line of the sub pixel region;
a source, connected to the corresponding sub data line of the sub pixel region; and
a drain, connected to the sub pixel electrode.

13. The array substrate according to claim 12, wherein the first switch elements, the second switch elements and the switch elements are a thin film transistor.

14. The array substrate according to claim 8, wherein each of the sub data lines is disposed on an identical side corresponding to one main data line thereof.

15. The array substrate according to claim 14, wherein the sub data lines are disposed along an extending direction corresponding to the main data lines thereof.

16. A liquid crystal display panel, comprising:
a first substrate, comprising:
a plurality of gate lines, disposed on the array substrate;
a plurality of main data lines, disposed on the array substrate;
a plurality of first switch elements;
a plurality of sub data lines, wherein each of the sub data lines is connected to one corresponding main data line through one corresponding first switch element to receive a data signal transmitted by the corresponding main data line;
a plurality of pixel regions, formed in a plurality of regions in which the gate lines and the main data lines are intersected each other, and each of the pixel regions comprises:
a main pixel region, connected to one corresponding main data line and one corresponding gate line;
a sub pixel region, connected to one corresponding sub data line and one corresponding gate line;
a second substrate, disposed opposite to the first substrate;
a liquid crystal layer, clipped between the first substrate and the second substrate;
wherein, in each of the pixel regions, the corresponding gate line connected to the main pixel region and the corresponding gate line connected to the sub pixel region are one identical gate line, and the corresponding main data line connected to the main pixel region and the corresponding sub data line connected to the sub pixel region are the main data line and the sub data line connected through one corresponding first switch element.

17. The liquid crystal display panel according to claim 16, wherein the plurality of first switch elements are controlled by a first clock signal, the first clock signal makes the data signals of the sub data lines the data relative to the data signals of the corresponding main data lines to delay a predetermined time, such that in each of the pixel regions, a charging time of the sub pixel is smaller than a charging time of the main pixel region.
